(19) United States
(12) Patent Application Publication
(10) Pub. No.: US 2011/0173445 A1
(43) Pub. Date: Jul. 14, 2011

(54) SYSTEM AND METHOD FOR CONTENT BASED APPLICATION OF SECURITY LEVELS TO ELECTRONIC DOCUMENTS

(76) Inventors: Sameer Yami, Irvine, CA (US); William Su, Riverside, CA (US); Michael L. Yeung, Mission Viejo, CA (US); Hongfeng Wei, Cerritos, CA (US)

(21) Appl. No.: 12/194,186

(22) Filed: Aug. 19, 2008

(51) Int. Cl. G06F 12/14

(52) U.S. Cl. 713/166

(57) ABSTRACT

The subject application is directed to a system and method for automated application of security levels to electronic documents.

1). Text data associated with text content of each of a plurality of stored electronic documents is stored in a data storage, each of the stored electronic documents having a security level associated therewith. An electronic document inclusive of text data comprising a plurality of text strings is received, and the text strings are compared with text data in at least one of the stored electronic documents. A security level is assigned to the received electronic document at a level associated with a stored electronic document in accordance with an output of the comparison.

OR

2). Electronic documents are received and keyword data is extracted to generate an index file associated with each electronic document. The index file is then stored in association with its respective electronic document in an associated data storage. Upon receipt of an electronic document for processing, keyword data is extracted and compared to keyword data in the index files associated with each of the stored electronic documents. The security level associated with each matching stored electronic document is then identified to determine the highest security level from among the matching documents. The received electronic document is then assigned the highest determined security level.

### BACKGROUND OF THE INVENTION

The subject application is directed generally to security of electronic documents. The application is particularly directed to a system and method for applying security policy information to incoming electronic documents in an automated fashion.

Most institutions and individuals routinely rely on electronic data files as a mechanism to store and retrieve electronic documents. Certain electronic documents include more confidential information such as health information, financial information, personal information, or trade secrets. Often, there are multiple levels of security that may be associated with electronic files, which security level is assigned responsive to variables such as personal preference or company policy.

Incoming documents may be received in accordance with operation of document processing devices, which devices include copiers, scanners, printers, facsimile devices, electronic mail submissions, and the like. It is often difficult or time-consuming to accurately associate an appropriate security level with documents arriving from document processing devices.

### SUMMARY OF THE INVENTION

In accordance with one embodiment of the subject application, there is provided a system and method for automated application of security levels to electronic documents. Text data associated with text content of each of a plurality of stored electronic documents is stored in a data storage, each of the stored electronic documents having a security level associated therewith. An electronic document inclusive of text data comprising a plurality of text strings is received, and the text strings are compared with text data in at least one of the stored electronic documents. A security level is assigned to the received electronic document at a level associated with a stored electronic document in accordance with an output of the comparison.

Still other advantages, aspects, and features of the subject application will become readily apparent to those skilled in the art from the following description, wherein there is shown and described a preferred embodiment of the subject application, simply by way of illustration of one of the modes best suited to carry out the subject application. As it will be realized, the subject application is capable of other different embodiments, and its several details are capable of modifications in various obvious aspects, all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for automated application of security levels to electronic documents according to one embodiment of the subject application;

FIG. 2 is a block diagram illustrating device hardware for use in the system for automated application of security levels to electronic documents according to one embodiment of the subject application;

FIG. 3 is a functional diagram illustrating the device for use in the system for automated application of security levels to electronic documents according to one embodiment of the subject application;

FIG. 4 is a block diagram illustrating controller hardware for use in the system for automated application of security levels to electronic documents according to one embodiment of the subject application;

FIG. 5 is a functional diagram illustrating the controller for use in the system for automated application of security levels to electronic documents according to one embodiment of the subject application;

FIG. 6 is a functional diagram illustrating the system for automated application of security levels to electronic documents according to one embodiment of the subject application;

FIG. 7 is a flowchart illustrating a method for automated application of security levels to electronic documents according to one embodiment of the subject application; and

FIG. 8 is a flowchart illustrating a method for automated application of security levels to electronic documents according to one embodiment of the subject application.

### DETAILED DESCRIPTION OF THE PREFERRED EMBODIMENT

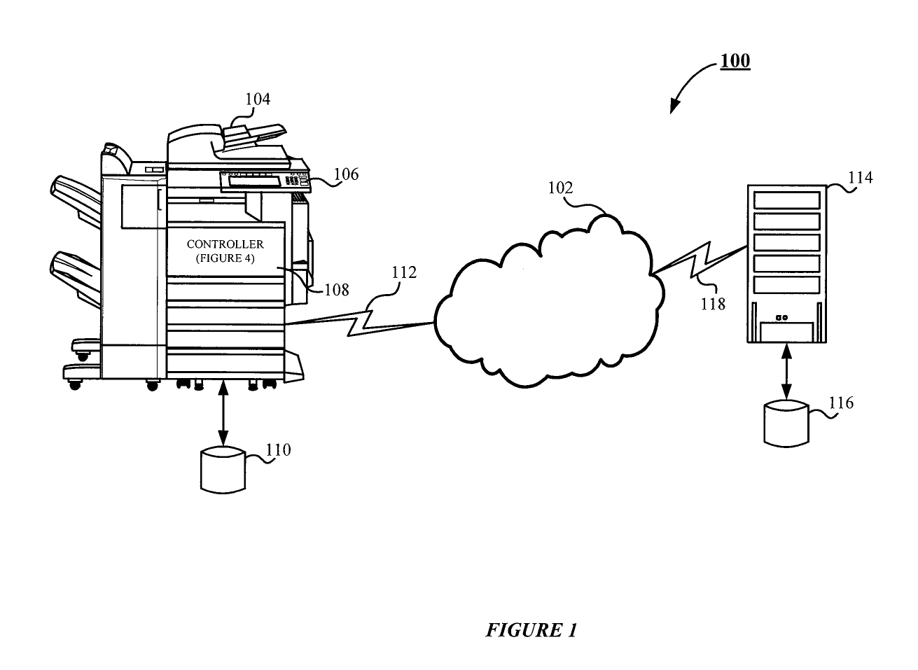

The subject application is directed to a system and method for securing electronic documents. In particular, the subject application is directed to a system and method for applying security policy information to incoming electronic documents in an automated fashion. It will become apparent to those skilled in the art that the system and method described herein are suitably adapted to a plurality of varying electronic fields employing security levels including, for example and without limitation, communications, general computing, data processing, document processing, and the like. The preferred embodiment, as depicted in FIG. 1, illustrates a document processing field for example purposes only and is not a limitation of the subject application solely to such a field.

Referring now to FIG. 1, there is shown an overall diagram of a system 100 for automated application of security levels to electronic documents in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art that is capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or any suitable combination thereof. In accordance with the preferred embodiment of the subject application, the computer network 102 is comprised of physical layers and transport layers, as illustrated by myriad conventional data transport mechanisms such as, for example and without limitation, Token-Ring, 802.11(x), Ethernet, or other wireless or wire-based data communication mechanisms. The skilled artisan will appreciate that, while a computer network 102 is shown in FIG. 1, the subject application is equally capable of use with a stand-alone system, as will be known in the art.

The system 100 also includes a document processing device 104, which is depicted in FIG. 1 as a multifunction peripheral device suitably adapted to perform a variety of document processing operations. It will be appreciated by those skilled in the art that such document processing operations include, for example and without limitation, facsimile, scanning, copying, printing, electronic mail, document management, document storage, and the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like.

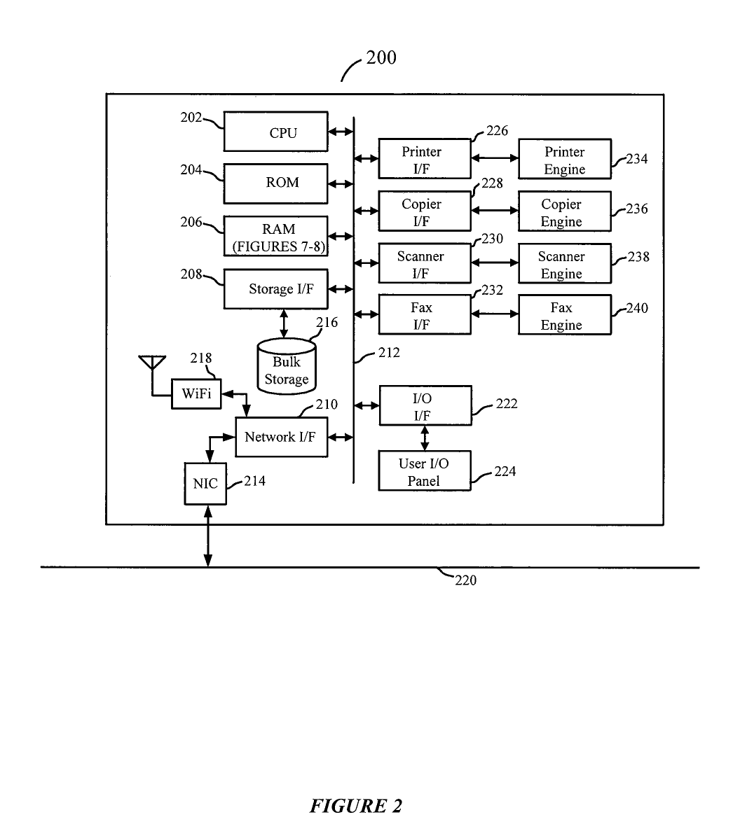

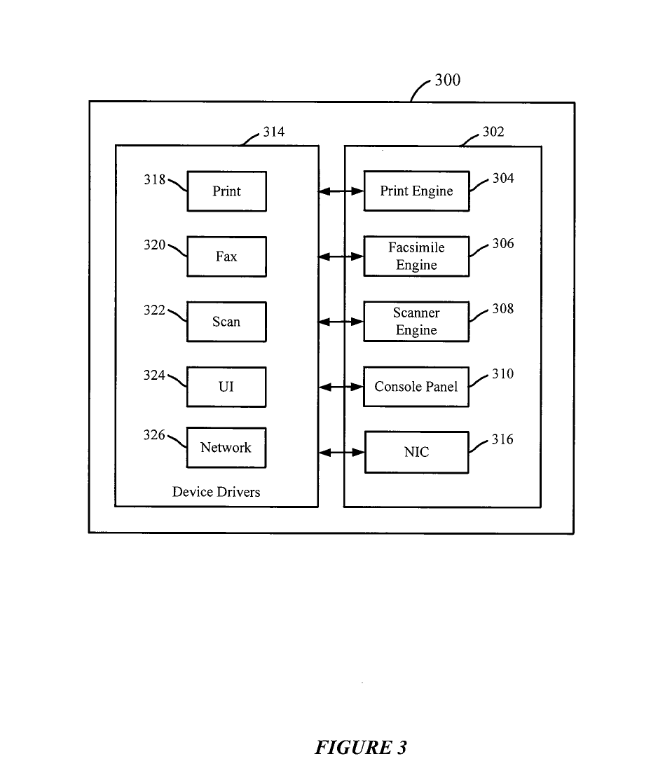

According to one embodiment of the subject application, the document processing device 104 is suitably equipped to receive a plurality of portable storage media including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and to receive selections from the associated user. The skilled artisan will appreciate that the user interface 106 comprises various components suitably adapted to present data to the associated user, as are known in the art. In accordance with one embodiment of the subject application, the user interface 106 comprises a display suitably adapted to display one or more graphical elements, text data, images, or the like to an associated user, to receive input from the associated user, and to communicate the same to a backend component, such as the controller 108, as is explained in greater detail below. Preferably, the document processing device 104 is communicatively coupled to the computer network 102 via a communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The functioning of the document processing device 104 will be better understood in conjunction with the block diagrams illustrated in FIGS. 2 and 3, as is explained in greater detail below.

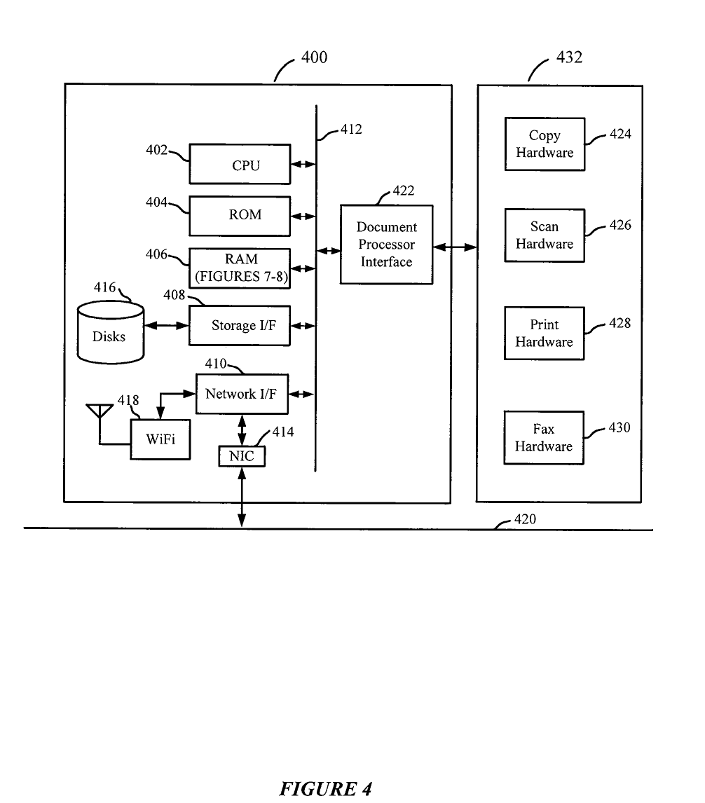

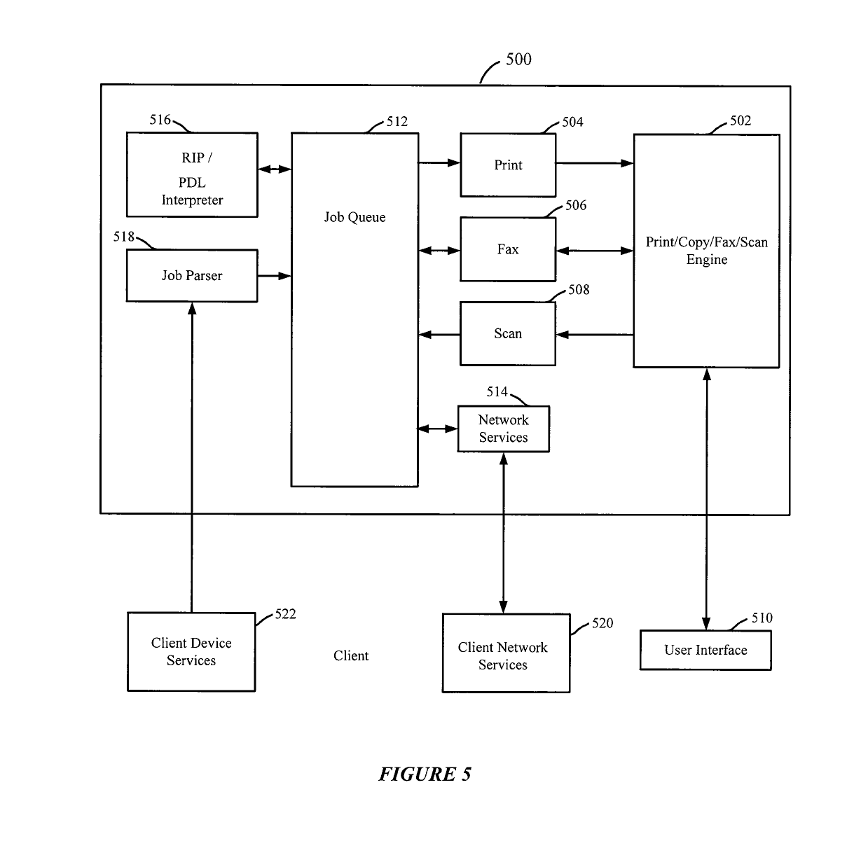

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof configured to control the operations of the associated document processing device 104, to facilitate the display of images via the user interface 106, to direct the manipulation of electronic image data, and the like. For purposes of explanation, the controller 108 is used to refer to any of the myriad components associated with the document processing device 104 including hardware, software, or combinations thereof functioning to perform, cause to be performed, control, or otherwise direct the methodologies described hereinafter. It will be understood by those skilled in the art that the methodologies described with respect to the controller 108 are capable of being performed by any general purpose computing system known in the art, and thus the controller 108 is representative of such general computing devices and is intended as such when used hereinafter. Furthermore, the use of the controller 108 hereinafter is for the example embodiment only, and other embodiments, which will be apparent to one skilled in the art, are capable of employing the system and method for automated application of security levels to electronic documents of the subject application. The functioning of the controller 108 will better be understood in conjunction with the block diagrams illustrated in FIGS. 4 and 5, as explained in greater detail below.

Communicatively coupled to the document processing device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store document data, image data, electronic database data, or the like. It will be appreciated by those skilled in the art that, while illustrated in FIG. 1 as being a separate component of the system 100, the data storage device 110 is capable of being implemented as an internal storage component of the document processing device 104, a component of the controller 108, or the like such as, for example and without limitation, an internal hard disk drive or the like. In accordance with one embodiment of the subject application, the data storage device 110 is capable of storing images, advertisements, user information, location information, output templates, mapping data, multimedia data files, fonts, and the like.

The system 100 illustrated in FIG. 1 further depicts a backend component, shown as the server 114, in data communication with the computer network 102 via a communications link 118. It will be appreciated by those skilled in the art that the server 114 is shown in FIG. 1 as a component of the system 100 for example purposes only, and the subject application is capable of implementation via a standalone document processing device 104. The skilled artisan will appreciate that the server 114 comprises hardware, software, and combinations thereof suitably adapted to provide one or more services, web-based applications, storage options, and the like to networked devices. In accordance with one example embodiment of the subject application, the server 114 includes various components implemented as hardware, software, or a combination thereof for managing retention of secured documents, text data, performing searches, comparisons, account information, retrieval of documents, and the like, which are accessed via the computer network 102. The communications link 118 is any suitable data communications means known in the art including but not limited to wireless communications comprising, for example and without limitation, Bluetooth, WiMax, 802.11a, 802.11b, 802.11g, 802.11(x), a proprietary communications network, infrared, the public switched telephone network, optical, or any suitable wireless data transmission system or wired communications known in the art. It will be further appreciated by those skilled in the art that the components described with respect to the server 114 are capable of implementation on any suitable computing device coupled to the computer network 102, e.g. the controller 108, or the like.

Communicatively coupled to the server 114 is a data storage device 116. According to the foregoing example embodiment, the data storage device 116 is any mass storage device, or plurality of such devices, known in the art including, for example and without limitation, magnetic storage drives, a hard disk drive, optical storage devices, flash memory devices, or any suitable combination thereof. In such an embodiment, the data storage device 116 is suitably adapted to store software updates, secured electronic documents, text data, data strings, account information, policy information, and the like. It will be appreciated by those skilled in the art that, while illustrated in FIG. 1 as being a separate component of the system 100, the data storage device 116 is capable of being implemented as an internal storage component of the server 116 or the like such as, for example and without limitation, an internal hard disk drive or the like.

Turning now to FIG. 2, illustrated is a representative architecture of a suitable device 200, shown in FIG. 1 as the document processing device 104, on which operations of the subject system are completed. Included is a processor 202, suitably comprised of a central processor unit. However, it will be appreciated that the processor 202 may be advantageously composed of multiple processors working in concert with one another, as will be appreciated by one of ordinary skill in the art. Also included is a non-volatile or read only memory 204, which is advantageously used for static or fixed data or instructions such as BIOS functions, system functions, system configuration data, and other routines or data used for operation of the device 200.

Also included in the device 200 is random access memory 206 suitably formed of dynamic random access memory, static random access memory, or any other suitable, addressable memory system. Random access memory 206 provides a storage area for data instructions associated with applications and data handling that are accomplished by the processor 202.

A storage interface 208 suitably provides a mechanism for volatile, bulk, or long term storage of data associated with the device 200. The storage interface 208 suitably uses bulk storage such as any suitable addressable or serial storage, such as a disk, optical, tape drive and the like as shown as 216, as well as any suitable storage medium, as will be appreciated by one of ordinary skill in the art.

A network interface subsystem 210 suitably routes input and output from an associated network, allowing the device 200 to communicate to other devices. The network interface subsystem 210 suitably interfaces with one or more connections with external devices to the device 200. By way of example, illustrated is at least one network interface card 214 for data communication with fixed or wired networks such as Ethernet, Token-Ring, and the like and a wireless interface 218 suitably adapted for wireless communication via means such as WiFi, WiMax, wireless modem, cellular network, or any suitable wireless communication system. It is to be appreciated, however, that the network interface subsystem 210 suitably utilizes any physical or non-physical data transfer layer or protocol layer, as will be appreciated by one of ordinary skill in the art. In the illustration, the network interface card 214 is interconnected for data interchange via a physical network 220 suitably comprised of a local area network, wide area network, or a combination thereof.

Data communication between the processor 202, read only memory 204, random access memory 206, storage interface 208, and the network subsystem 210 is suitably accomplished via a bus data transfer mechanism, such as is illustrated by the bus 212.

Suitable executable instructions on the device 200 facilitate communication with a plurality of external devices such as workstations, document processing devices, other servers, or the like. While, during operation, a typical device operates autonomously, it is to be appreciated that direct control by a local user is sometimes desirable and is suitably accomplished via an optional input/output interface 222 to a user input/output panel 224, as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device 300, depicted in FIG. 1 as the document processing device 104, for use in connection with the disclosed system. FIG. 3 illustrates suitable functionality of the hardware of FIG. 2 in connection with software and operating system functionality, as will be appreciated by one of ordinary skill in the art. The document processing device 300 suitably includes a document processing engine 302, which facilitates one or more document processing operations.

The document processing engine 302 suitably includes a print engine 304, facsimile engine 306, scanner engine 308, and console panel 310. The print engine 304 allows for output of physical documents representative of an electronic document communicated to the processing device 300. The facsimile engine 306 suitably communicates to or from external facsimile devices via a device such as a fax modem.

The scanner engine 308 suitably functions to receive hard copy documents and, in turn, image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer such as wired, wireless, or optical data communication.

The document processing engine 302 is suitably in data communication with one or more device drivers 314, which device drivers 314 allow for data interchange from the document processing engine 302 to one or more physical devices to accomplish the actual document processing operations. Such document processing operations include one or more of printing via driver 318, facsimile communication via driver 320, scanning via driver 322 and user interface functions via driver 324. It will be appreciated that these various devices are integrated with one or more corresponding engines associated with the document processing engine 302. It is to be appreciated that any set or subset of document processing operations are contemplated herein. Document processors that include a plurality of available document processing options are referred to as multi-function peripherals.

Turning now to FIG. 4, illustrated is a representative architecture of a suitable backend component, i.e., the controller 400, shown in FIG. 1 as the controller 108, on which operations of the subject system 100 are completed. The skilled artisan will understand that the controller 400 is representative of any general computing device known in the art that is capable of facilitating the methodologies described herein. Included is a processor 402 suitably comprised of a central processor unit. However, it will be appreciated that processor 402 may be advantageously composed of multiple processors working in concert with one another, as will be appreciated by one of ordinary skill in the art. Also included is a non-volatile or read only memory 404, which is advantageously used for static or fixed data or instructions such as BIOS functions, system functions, system configuration data, and other routines or data used for operation of the controller 400.

Also included in the controller 400 is random access memory 406 suitably formed of dynamic random access memory, static random access memory, or any other suitable addressable and writable memory system. Random access memory 406 provides a storage area for data instructions associated with applications and data handling that are accomplished by processor 402.

A storage interface 408 suitably provides a mechanism for non-volatile, bulk, or long term storage of data associated with the controller 400. The storage interface 408 suitably uses bulk storage such as any suitable addressable or serial storage, such as a disk, optical, tape drive and the like as shown as 416, as well as any suitable storage medium, as will be appreciated by one of ordinary skill in the art.

A network interface subsystem 410 suitably routes input and output from an associated network, allowing the controller 400 to communicate to other devices. The network interface subsystem 410 suitably interfaces with one or more connections with external devices to the device 400. By way of example, illustrated is at least one network interface card 414 for data communication with fixed or wired networks such as Ethernet, Token-Ring, and the like and a wireless interface 418 suitably adapted for wireless communication via means such as WiFi, WiMax, wireless modem, cellular network, or any suitable wireless communication system. It is to be appreciated, however, that the network interface subsystem 410 suitably utilizes any physical or non-physical data transfer layer or protocol layer, as will be appreciated by one of ordinary skill in the art. In the illustration, the network interface card 414 is interconnected for data interchange via a physical network 420 suitably comprised of a local area network, wide area network, or a combination thereof.

Data communication between the processor 402, read only memory 404, random access memory 406, storage interface 408, and the network interface subsystem 410 is suitably accomplished via a bus data transfer mechanism, such as is illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 400 of FIG. 4, (shown in FIG. 1 as the controller 108) as an intelligent subsystem associated with a document processing device. In the illustration of FIG. 5, controller function 500 in the preferred embodiment includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality, as will be appreciated by one of ordinary skill in the art.

In the preferred embodiment, the engine 502 allows for printing operations, copy operations, facsimile operations, and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited-purpose document processing devices that perform one or more of the document processing operations listed above.

The engine 502 is suitably interfaced to a user interface panel 510, which panel 510 allows for a user or administrator to access functionality controlled by the engine 502. Access is suitably enabled via an interface local to the controller or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 508 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network-based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter, or any suitable mechanism for interchange of an electronic document to a format better suited for interchange with device functions such as print 504, facsimile 506, or scan 508.

Finally, the job queue 512 is in data communication with a parser 518, which parser 518 suitably functions to receive print job language files from an external device such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

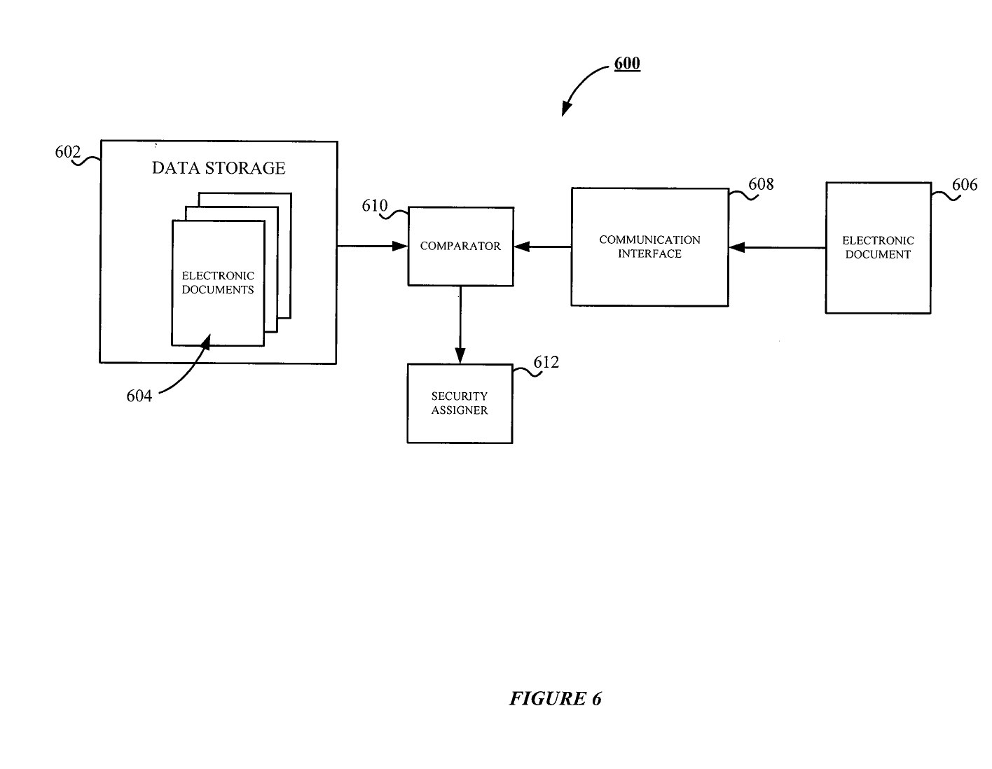

Turning now to FIG. 6, illustrated is a functional diagram of a system 600 for automated application of security levels to electronic documents in accordance with one embodiment of the subject application. As shown in FIG. 6, the system 600 includes a data storage 602 storing a plurality of electronic documents 604. It will be appreciated by those skilled in the art that the system 600 is capable of being implemented on the document processing device 104 of FIG. 1, as individual components, or a suitable combination thereof. Preferably, the data storage 602 includes text data associated with the text content of each of the plurality of electronic documents 604. In accordance with a preferred embodiment of the subject application, each of the stored electronic documents 604 has an associated security level.

An electronic document 606, to which a security level is to be applied, is then received by the communication interface 608 from an associated user. The received electronic document 606 suitably includes, for example and without limitation, text data comprising a plurality of text strings, as will be appreciated by those skilled in the art. The text strings of the received electronic document 606 are then communicated from the communication interface 608 to a comparator 610. The comparator 610 then compares the text strings in the received electronic document 606 with text strings in the stored electronic documents 604. Preferably, the comparison performed by the comparator 610 comprises the locating of text strings in the stored documents 604 that match the text strings in the received electronic document 606. One or more matching electronic documents 604 are then returned by the comparator 610, and such comparison results are forwarded to a security assigner 612. The security assigner 612 analyzes the comparison results and determines which of the matching electronic documents 604 has the highest associated security level. Once the highest security level of a matching electronic document 604 has been determined, the security assigner 612 assigns that security level to the received electronic document 606.

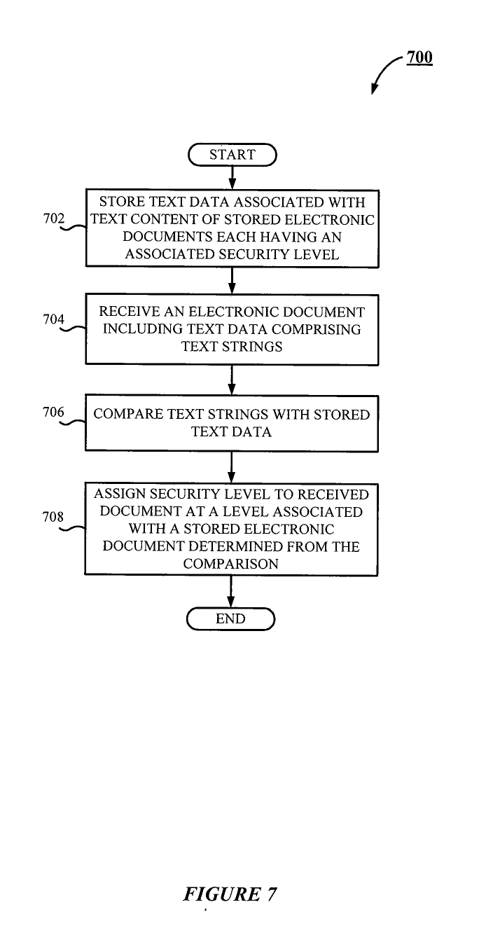

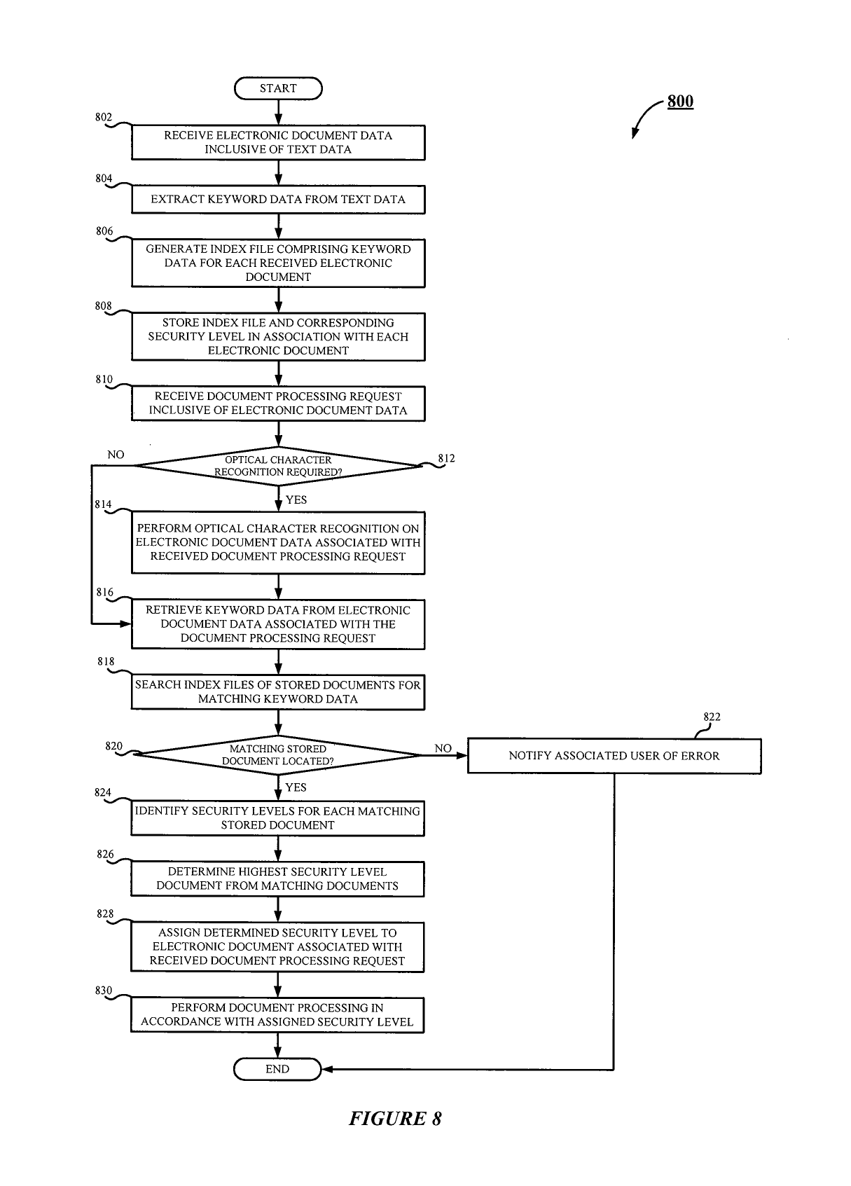

The skilled artisan will appreciate that the subject system 100 and components described above with respect to FIG. 1, FIG. 2, FIG. 3, FIG. 4, FIG. 5, and FIG. 6 will be better understood in conjunction with the methodologies described hereinafter with respect to FIG. 7 and FIG. 8. Turning now to FIG. 7, there is shown a flowchart 700 illustrating a method for automated application of security levels to electronic documents in accordance with one embodiment of the subject application. Beginning at step 702, text data associated with text content of each of a plurality of stored electronic documents is stored in a data storage. For example, the data storage device 110 associated with the document processing device 104 stores multiple electronic documents, each of which has an associated security level.

At step 704, an electronic document including text data comprising a plurality of text strings is then received. In accordance with one embodiment of the subject application, the electronic document data is capable of being received by the document processing device 104 via scanning/facsimile operations, printing operations, file-transfer operations, or the like. The controller 108 or other suitable component associated with the document processing device 104 then compares the text strings in the text string data of the received electronic document with text data in at least one of the stored electronic documents at step 706. At step 708, a security level is then assigned to the received electronic document by the controller 108 or other suitable component associated with the document processing device 104 at a level associated with a stored electronic document based upon the output of the comparison performed at step 706.

Referring now to FIG. 8, there is shown a flowchart 800 illustrating a method for automated application of security levels to electronic documents in accordance with one embodiment of the subject application. The methodology of FIG. 8 begins at step 802, whereupon electronic document data is received by the controller 108 or other suitable component associated with the document processing device 104. The electronic document data suitably includes an associated security level, e.g. watermarking, digital rights management, encryption, user tracking, or the like. According to one embodiment of the subject application, the electronic document further includes text data corresponding to content associated with the electronic document. The skilled artisan will appreciate that, while reference is made in FIG. 8 to the document processing device 104 receiving the electronic document data, the server 114 is equally capable of being implemented to receive such data and perform one or more additional steps of the flowchart 800 in accordance with the subject application.

At step 804, the controller 108 or other suitable component associated with the document processing device 104 extracts keyword data from the text data associated with the received electronic document data. An index file is then generated for each received electronic document comprising the extracted keyword data at step 806. At step 808, the index file and corresponding security level are then stored in association with each corresponding electronic document in the data storage 110 associated with the document processing device 104. In accordance with one embodiment of the subject application, the server 114 is implemented to extract keyword, generate an index files, and store the index file and associated electronic document data in the associated data storage 116. The skilled artisan will appreciate that, while the received electronic document data is used in reference to FIG. 8 as representative of one or more electronic documents, text strings or other expressions are equally capable of being used for the extraction of keyword data and generation of suitable index files in accordance with the method for automated application of security levels to electronic documents.

At step 810, the document processing device 104 receives a document processing request from an associated user inclusive of electronic document data comprising at least one electronic document. The skilled artisan will appreciate that such receipt is capable of occurring via operation of the document processing device 104, e.g. scanning, copying, printing, facsimile transmission, electronic mail transmission, retrieval from portable or network storage, or the like. The controller 108 or other suitable component associated with the document processing device 104 then determines at step 812 whether optical character recognition is required by the electronic document data received from the associated user. It will be appreciated by those skilled in the art that certain electronic document data is received as image data, e.g. a scan job, copy job, facsimile transmission, etc., such that the data is not discernible for purposes of text extraction.

Upon a determination that the received electronic document data requires optical character recognition, flow proceeds to step 814. At step 814, the controller 108 or other suitable component associated with the document processing device 104 performs optical character recognition on the received electronic document associated with the document processing request. Following completion of the optical character recognition at step 814, or upon a determination at step 812 that such optical character recognition is not required, operations progress to step 816.

At step 816, the controller 108 or other suitable component associated with the document processing device 104 retrieves, or extracts, keyword data from the received electronic document. A search is then performed at step 818 of the index files in the data storage 110 for matching keyword data. It will be appreciated by those skilled in the art that the document processing device 104 is capable of maintaining a local index of keyword data and associated electronic documents via the local data storage 110. According to one embodiment of the subject application, the document processing device 104 communicates the retrieved keyword data to the server 114, which then performs a search of index files of electronic documents in the data storage 116 for a match corresponding thereto.

A determination is then made at step 820, either by the controller 108 or the server 114, whether one or more matching electronic documents have been located in the data storage 110 or 116, respectively. That is, a determination is made as to whether the keyword data extracted from the received electronic document matches the keyword data in any of the index files associated with the stored documents. When no match is located, the associated user is notified of the error at step 822, e.g. via the user interface 106, electronic mail notification, an audible tone, or the like.

Upon a determination that one or more stored electronic documents correspond to the keyword data extracted from the received document, operations proceed to step 824. It will be understood by those skilled in the art that, when the server 114 is tasked with performing the search, the server 114 returns the one or more electronic documents to the document processing device 104 via the computer network 102 for further processing in accordance with one embodiment of the subject application. At step 824, the security levels for each of the matching stored documents are identified by the controller 108 or other suitable component associated with the document processing device 104 or via the server 114. Following identification of the security levels, the controller 108 or other suitable component associated with the document processing device determines which of the identified electronic documents has the highest associated security level at step 826. The highest determined security level from the matching electronic documents is then assigned by the controller 108 or other suitable component associated with the document processing device 104 to the electronic document associated with the received document processing request at step 828, whereupon further processing in accordance with the assigned security level is enabled at step 830. In accordance with one embodiment of the subject application, the security levels are determined based upon a desired policy, such that keyword data is directly associated with a security level in accordance with a predetermined policy.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally, and equitably entitled.

What is claimed:

1. A system for automated application of security levels to electronic documents, comprising:
a data storage, into which is received text data associated with text content of each of a plurality of stored electronic documents, each of the stored electronic documents having a security level associated therewith;
a communication interface, into which is received an electronic document inclusive of text data comprising a plurality of text strings;
a comparator, which compares text strings in the text string data with text data in at least one of the stored electronic documents; and
a security assigner, which assigns a security level to the received electronic document at a level associated with a stored electronic document in accordance with an output of the comparator.

2. The system of claim 1, wherein the text data corresponds to pre-selected keywords.

3. The system of claim 2, wherein the text data is included in an index file associated with each of the plurality of stored electronic documents.

4. The system of claim 1, wherein the comparator compares the text strings in the text string data with text data associated with each of the plurality of stored electronic documents having differing security levels associated therewith, and wherein the security assigner assigns a security level to the received electronic document in accordance with the highest security level of the plurality of stored documents.

5. The system of claim 1, further comprising a document processing device selected from the set comprising a scanner, copier, facsimile device, printer, and electronic mail client, and wherein the electronic document is received from the document processing device.

6. The system of claim 2, further comprising means adapted for associating a security level with the text data in accordance with policy data corresponding to an institutional security policy.

7. A method for automated application of security levels to electronic documents, comprising the steps of:
storing, in a data storage, text data associated with text content of each of a plurality of stored electronic documents, each of the stored electronic documents having a security level associated therewith;
receiving an electronic document inclusive of text data comprising a plurality of text strings;
comparing text strings in the text string data with text data in at least one of the stored electronic documents; and
assigning a security level to the received electronic document at a level associated with a stored electronic document in accordance with an output of the comparison.

8. The method of claim 7, wherein the text data corresponds to pre-selected keywords.

9. The method of claim 8, wherein the text data is included in an index file associated with each of the plurality of stored electronic documents.

10. The method of claim 7, wherein the comparing step includes comparing the text strings in the text string data with text data associated with each of the plurality of stored electronic documents having differing security levels associated therewith, and wherein the step of assigning a security level assigns a security level to the received electronic document in accordance with the highest security level of the plurality of stored documents.

11. The method of claim 7, wherein the electronic document is received from a document processing device selected from the set comprising a scanner, copier, facsimile device, printer, and electronic mail client.

12. The method of claim 8, further comprising the step of associating a security level with the text data in accordance with policy data corresponding to an institutional security policy.

13. A system for automated application of security levels to electronic documents, comprising:
a data storage, including means adapted for storing text data associated with text content of each of a plurality of stored electronic documents, each of the stored electronic documents having a security level associated therewith;
means adapted for receiving an electronic document inclusive of text data comprising a plurality of text strings;
comparison means adapted for comparing text strings in the text string data with text data in at least one of the stored electronic documents; and
security means adapted for assigning a security level to the received electronic document at a level associated with a stored electronic document in accordance with an output of the comparison means.

14. The system of claim 13, wherein the text data corresponds to pre-selected keywords.

15. The system of claim 14, wherein the text data is included in an index file associated with each of the plurality of stored electronic documents.

16. The system of claim 13, wherein the comparison means includes means adapted for comparing the text strings in the text string data with text data associated with each of the plurality of stored electronic documents having differing security levels associated therewith, and wherein the security means assigns a security level to the received electronic document in accordance with the highest security level of the plurality of stored documents.

17. The system of claim 13, further comprising a document processing device selected from the set comprising a scanner, copier, facsimile device, printer, and electronic mail client, and wherein the electronic document is received from the document processing device.

18. The system of claim 14, further comprising means adapted for associating a security level with the text data in accordance with policy data corresponding to an institutional security policy.
